(19) United States
(12) Patent Application Publication
(10) Pub. No.: US 2014/0042012 A1
(43) Pub. Date: Feb. 13, 2014

(54) OZONE GENERATION SYSTEM WITH PRECISION CONTROL

(71) Applicants: Michele Clement, Saint-Lambert (CA); Donald L. Lulham, Pierrefonds (CA); Raymond Latour, Edmonton (CA); William J. Converse, Johnson city, TN (US); Robert Clavel, St- Hubert (CA)

(72) Inventors: Michele Clement, Saint-Lambert (CA); Donald L. Lulham, Pierrefonds (CA); Raymond Latour, Edmonton (CA); William J. Converse, Johnson city, TN (US); Robert Clavel, St- Hubert (CA)

(73) Assignee: Ecovie Canada Technologies Inc., Quebec (CA)

(21) Appl. No.: 13/989,039

(22) PCT Filed: Nov. 22, 2011
(86) PCT No.: PCT/CA11/50724

§ 371 Date: Sep. 23, 2013

Related U.S. Application Data
(60) Provisional application No. 61/416,244, filed on Nov. 22, 2010.

(51) Int. Cl. C01B 13/11; H02M 7/06

(52) U.S. Cl. CPC C01B 13/115; H02M 7/06
USPC 204/176; 363/47; 422/109

(57) ABSTRACT

There is described herein a direct current power supply which offers improved control over an output signal. An input signal generated by an alternating current source is received and chopped by a solid state relay. The chopped signal is rectified by a bridge rectifier before being filtered by an “LC” (induction coil-capacitor) or “CLC” (capacitor-induction coil-capacitor) filter. The output signal can then be used as a direct current power supply signal. This power supply may be used in various types of ozone generation systems.

### CROSS-REFERENCE TO RELATED APPLICATIONS

The present application claims priority under 35 USC 119(e) of U.S. Provisional Patent Application No. 61/416,244, filed on Nov. 22, 2010, the contents of which are hereby incorporated by reference.

### TECHNICAL FIELD

The present invention relates to the field of ozone generation systems, and particularly, to such systems that require a high level of control or precision at their outputs due to the potentially toxic nature of ozone, and the difficulty of outputting high concentrations to neutralize pollutants while ensuring minimal residual concentrations for safety reasons.

### BACKGROUND OF THE ART

Control of an ozone generation system is provided at least in part by a DC power supply. There are many different implementations for power supplies as they are used in a wide variety of applications. Regulated power supplies allow an output voltage or current to be set to a specific value that is held nearly constant despite variations in either load current or voltage supplied by the power supply's energy source. Variable power supplies can be adjusted over a range of voltages or currents, depending on the available range.

An application such as ozone generation requires very precise control of the output of the power supply and a wide range of variability. Power supplies presently used with ozone generators typically use a Triac for Alternating Current triggered by a Diode for Alternating Current (DIAC) to vary the alternating current (AC) supplied to a capacitor bank. However, such a circuit can only start at about 30% of the full voltage available due to the turn-on voltage needed by the DIAC. Such power supplies are therefore not fully variable and poorly applicable to ozone generation.

### SUMMARY

There is described herein a direct current power supply which offers improved control over an output signal. An input signal generated by an alternating current source is received and chopped by a solid state relay. The chopped signal is rectified by a bridge rectifier before being filtered by an “LC” (induction coil-capacitor) or “CLC” (capacitor-induction coil-capacitor) filter. The output signal can then be used as a direct current power supply signal. This power supply may be used in various types of ozone generation systems.

There is also described herein an ozone generation system having the above-described power supply, as well as a high precision ozone sensor unit, a control unit having a control device to vary corona frequency as well as corona voltage, a control loop feedback mechanism, and an interface for setting control parameters, either locally or remotely. An ozone generator may comprise a series of valves for dynamically delivering controlled amounts of generated ozone into a given space.

In accordance with a first broad aspect, there is provided an ozone generation system comprising: an ozone generator adapted to deliver a given amount of ozone in a space in order to obtain a target concentration therein; a variable direct current power supply connected to the ozone generator and having a first input for receiving an alternating current power signal and a second input for an external control signal; a control unit connected to the second input of the power supply for generating the external control signal, the external control signal being generated in accordance with an amount of ozone required in order to reach the target concentration; and an ozone sensor connected to the control unit and adapted to measure a residual amount of ozone in the space and provide the control unit with a measurement signal of the residual amount for determining the amount of ozone required.

In accordance with another broad aspect, there is provided a method for generating ozone in a space, the method comprising: measuring a concentration of residual ozone in the space; determining, from the concentration measured, an amount of ozone required for providing a target concentration of ozone in the space; generating an external control signal for energizing a variable direct current power supply, the external control signal having a value selected in accordance with the amount of ozone required; energizing the variable direct current power supply with the external control signal and supplying the direct current power supply with an alternating current power signal; metering an amount of the alternating current power signal allowed to flow through the variable direct current power supply by varying a conduction angle thereof, thereby causing the variable direct current power supply to output a predetermined voltage level to an ozone generator; and delivering the amount of ozone required for providing the target concentration in the space.

In accordance with yet another broad aspect, there is provided a fully variable direct current power supply having a first input for receiving an alternating current power signal and a second input for an external control signal, the power supply comprising a solid-state relay and a rectifier, the solid state relay, connected to an input of the rectifier, adapted for metering the alternating current power signal presented to the rectifier from substantially 0% to substantially 100%, and a filter connected to an output of the rectifier for smoothing out a rectified signal and outputting a direct current voltage signal.

In accordance with another broad aspect, there is provided a method for generating a direct current voltage signal, the method comprising energizing the variable direct current power supply with an external control signal and an alternating current power signal, metering from substantially 0% to substantially 100% an amount of the alternating current power signal allowed to flow through the variable direct current power supply as a function of the external control signal by varying a conduction angle thereof using a solid state relay, rectifying an output of the solid state relay, filtering a rectified signal, and outputting a direct current voltage signal.

In this specification, the term “space” refers to any enclosed or semi-enclosed space. For example, a space may be enclosed by walls, a floor, and a ceiling. An enclosed space may have any appropriate size and be a room, an office, an industrial hangar, a house, a building, a storage tank, a processing room, or the like. A space may also be a semi-enclosed and have any appropriate size, such as a ventilating duct; a chimney; a room enclosed by three walls, a ceiling, and a floor; a room having only a floor and ceiling; or the like. The ceiling may be solid or made of cloth-like material.

The term “pollutants” refers to any pollutants or contaminants that may be present in air. A pollutant may be a chemical compound or a biological material. Odor-causing chemicals, viruses, bacteria, mold, and the like are examples of pollutants. While the present description refers to ozone concentrations expressed in ppb, it should be understood that the ozone concentrations may be expressed in other units such as in g/Hr for example, or in percentage.

### BRIEF DESCRIPTION OF THE DRAWINGS

Further features and advantages of the present invention will become apparent from the following detailed description, taken in combination with the appended drawings, in which:

FIG. 1 is a block diagram of an exemplary ozone generation system;

FIG. 2 is a block diagram of an exemplary control unit implemented as a computer system;

FIG. 3 is block diagram of an exemplary control unit comprising a digital PID;

FIG. 4 is a block diagram of an exemplary control unit comprising an analog PID;

FIG. 5 is a block diagram of an exemplary control unit comprising a hybrid PID;

FIG. 6 is a block diagram of an exemplary control unit comprising a stochastic PID;

FIG. 7 is a block diagram of an exemplary power supply;

FIG. 8 is a circuit diagram of an exemplary power supply with an LC filter;

FIG. 9 is a graph showing the output of the circuit shown in FIG. 8;

FIG. 10 is a circuit diagram of an exemplary power supply with an CLC filter;

FIG. 11 is a graph showing the output of the circuit shown in FIG. 10;

FIG. 12 is a circuit diagram of an exemplary corona-type ozone generation system;

FIG. 13 is a circuit diagram showing the ozone generation system of FIG. 12 with an added RMS/DC converter and a dryer system;

FIG. 14 is a circuit diagram showing the ozone generation system of FIG. 12 with an exemplary power supply circuit;

FIG. 15 is a block diagram showing an exemplary ozone measurement sub-system; and

FIG. 16 is a block diagram of an exemplary ozone generation system having proportional valves in the ozone generator.

It will be noted that throughout the appended drawings, like features are identified by like reference numerals.

### DETAILED DESCRIPTION

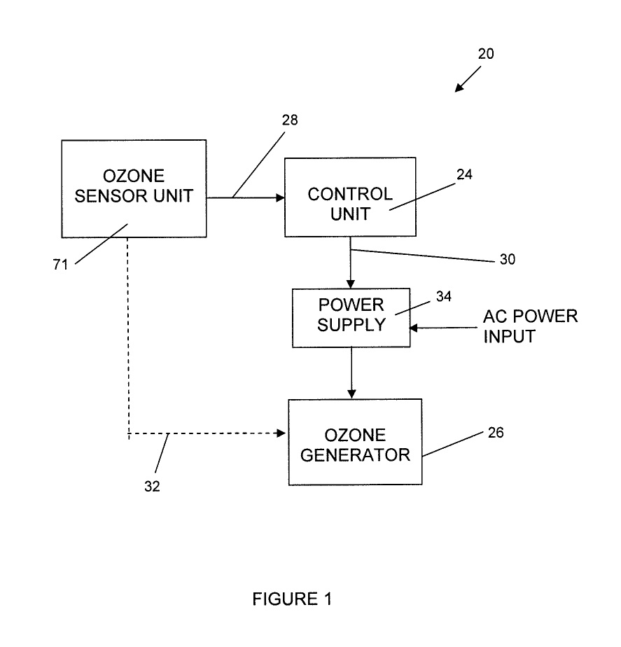

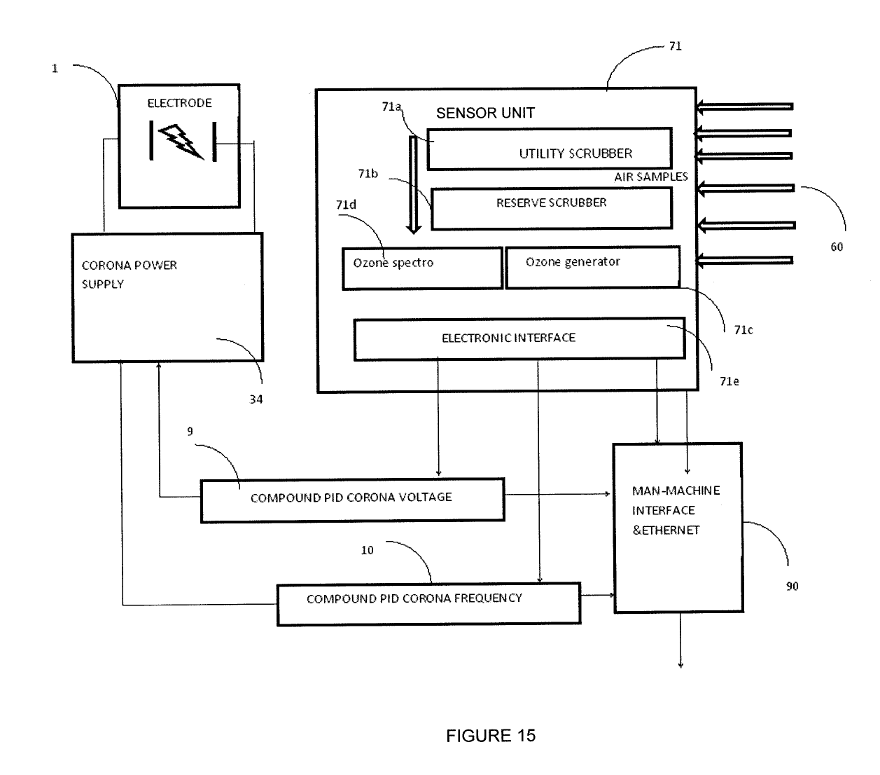

An ozone generation system generates and propagates Ozone (O₃) in a space in order to sanitize and/or deodorize the area by chemical reaction between the generated ozone and air pollutants present in the room. Depending on the amount of generated ozone and the quantity of pollutants, residual ozone may be present in the room. The residual ozone is the amount of ozone left over after reaction with the pollutants. FIG. 1 is an exemplary embodiment of an ozone generation system 20. The system 20 comprises an ozone sensor unit 71, a control unit 24, a power supply 34, and an ozone generator 26. The ozone sensor unit 71 is adapted to measure a concentration of ozone contained in air. It may be any appropriate type of sensor or gas analyzer adapted to detect and measure ozone. One exemplary embodiment is illustrated in more detail in FIG. 15.

The ozone sensor unit 71 is connected to the control unit 24 and adapted to transmit a signal 28 indicative of the measured residual ozone concentration to the control unit 24. The control unit 24 is adapted to determine the amount of ozone to be generated using the measured concentration and a target concentration for the residual ozone for obtaining a measured residual ozone concentration substantially equal to the target concentration. A power supply 34 is fed by the control unit 24 and is connected to the ozone generator 26.

The control unit is adapted to send a signal 30 to the power supply 34 having a level proportional to a determined amount of ozone to be generated by the ozone generator 26. The ozone generator 26 is adapted to generate the determined amount of ozone once powered by the power supply 34. The ozone generator 26 is in fluid communication with the room to be deodorized and/or sanitized. The ozone generator 26 may be located in a room. Alternatively, the ozone generator 26 may be located outside the room and a fluid connection may be provided between the ozone generator 26 and the room in order to deliver the generated ozone into the room.

In one embodiment, the ozone generation system 20 is adapted to continuously monitor the residual ozone concentration and adjust the amount of generated ozone. In another embodiment, the ozone generation system 20 is adapted to adjust the amount of generated ozone in a stepwise manner. In this case, the ozone sensor 71 is adapted to measure the residual ozone concentration at discrete points in time. Each time the sensor 71 measures the residual ozone concentration in the room, a measurement signal 28 is sent to the control unit 24. Upon reception of each measurement signal 28, the control unit 24 determines the appropriate amount of ozone to be generated and sends a control signal 30 indicative of the determined amount of ozone to be generated to the ozone generator 26 via the power supply 34. The power supply uses an AC power input signal to generate the required power for the ozone generation 26. The ozone generator 26 then adjusts and maintains the amount of generated ozone to the received value until a next measurement signal 30 is sent by the control unit 24.

In one embodiment, the control unit 24 is adapted to directly determine the amount of ozone to be generated using the measured concentration and the target concentration for the residual ozone. For example, the control unit 24 may comprise a memory in which a table comprising amounts of ozone to be generated as a function of residual ozone concentrations and target ozone concentrations is stored. The amounts of ozone to be generated may be experimental data that have been previously determined for different values of measured residual ozone concentration and target residual ozone concentration.

In another embodiment, the amount of ozone to be generated varies, and the control unit 24 is adapted to determine a variation of the amount of generated ozone using the measured concentration and the target concentration for the residual ozone. The determined variation corresponds to an increase or decrease of the quantity of the ozone generated by the ozone generator 26 in order to obtain a concentration of residual ozone in the room substantially equal to the target concentration. In one embodiment, the ozone sensor 71 is connected to the ozone generator 26 via connection 32, and adapted to stop the generation of ozone when the measured concentration of residual ozone is above a threshold value. In this case, a safety feature is added to the system 20 since the ozone sensor 71 is adapted to override the ozone generator 26 in case of malfunction of the control unit 24 and/or the ozone generator 26. For example, the threshold value may be equal to the target concentration. Alternatively, an additional ozone sensor independent from the sensor unit 71 may be connected to the ozone generator 26 and adapted to stop the generation of ozone when the measured concentration of residual ozone is above the threshold value. In another embodiment, the control unit 24 may be adapted to compare the measured concentration to a threshold value and stop the ozone generator 26 when the measured concentration is above the threshold value.

It should be understood that any appropriate control unit having a memory for storing the target value for the residual ozone concentration and adapted to process data in order to determine the amount of ozone to be generated or the variation of generated ozone required for obtaining the target concentration of residual ozone in the room may be used. For example, the control unit 24 may be a computer provided with a memory having the target concentration of residual ozone stored therein, and a central processing unit adapted to execute any appropriate control method such as a linear negative feedback method, a proportional method, a PID method, or the like.

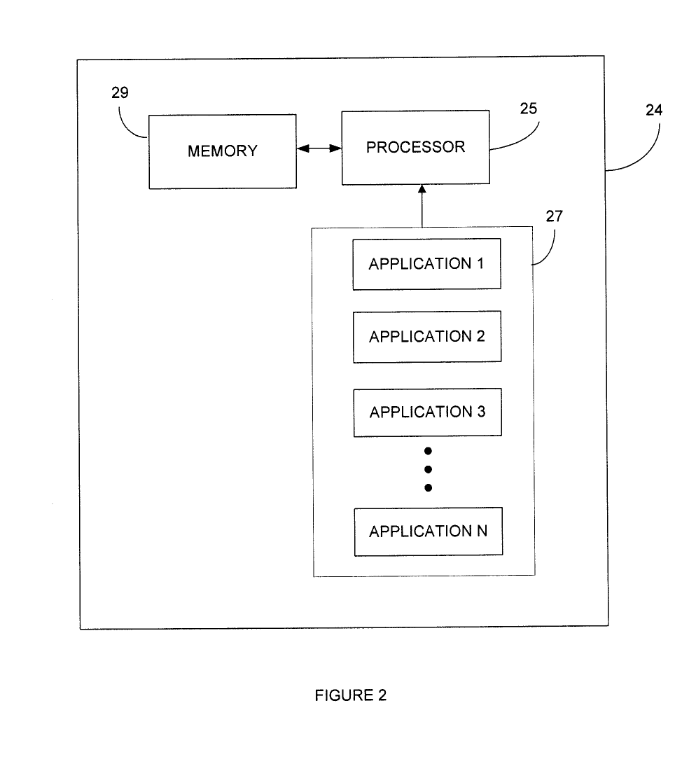

In one embodiment, illustrated in FIG. 2, the control unit 24 comprises, amongst other things, a plurality of applications 27 running on a processor 25, the processor being coupled to a memory 29. It should be understood that while the applications 27 presented herein are illustrated and described as separate entities, they may be combined or separated in a variety of ways. One or more databases (not shown) may be integrated directly into memory 29 or may be provided separately therefrom and remotely from the control unit 24. In the case of a remote access to the databases, access may occur via any type of network. The databases may be provided as collections of data or information organized for rapid search and retrieval by a computer. They may be structured to facilitate storage, retrieval, modification, and deletion of data in conjunction with various data-processing operations. They may consist of a file or sets of files that can be broken down into records, each of which consists of one or more fields. Database information may be retrieved through queries using keywords and sorting commands, in order to rapidly search, rearrange, group, and select the field. The databases may be any organization of data on a data storage medium, such as one or more servers.

In one embodiment, the databases are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). An SSL session may be started by sending a request to the Web server with an HTTPS prefix in the URL, which causes port number “443” to be placed into the packets. Port “4432 is the number assigned to the SSL application on the server. Identity verification of a user may be performed using usernames and passwords for all users. Various levels of access rights may be provided to multiple levels of users.

Any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The memory 29 accessible by the processor 25 receives and stores data. The memory 29 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc. The processor 25 may access the memory 29 to retrieve data. The processor 25 may be any device that can perform operations on data. Examples are a central processing unit (CPU), a front-end processor, a microprocessor, a graphics processing unit (GPUNPU), a physics processing unit (PPU), a digital signal processor, and a network processor. The applications 27 are coupled to the processor 25 and configured to perform various tasks as explained herein. An output may be transmitted to the power supply 34.

Alternatively, the control unit 24 may be a data processing electrical circuit adapted to store the target residual ozone concentration and determine the amount of ozone to be generated or the variation for the generated ozone using the measured concentration and the target concentration for the residual ozone. For example, the data processing electrical circuit may be a closed-loop analog controller.

In one embodiment, the control unit 24 comprises a PID controller adapted to determine the variation of generated ozone required for obtaining the target concentration of residual ozone in the room using the measured value and the target value for the residual ozone. In this case, the measurement signal 28 indicative of the measured residual ozone concentration may be an analog electrical signal of which the intensity is proportional to the measured concentration of residual ozone, and the control signal 30 indicative of the variation for the generated ozone may be an analog electrical signal of which the intensity is proportional to the determined variation for the generated ozone.

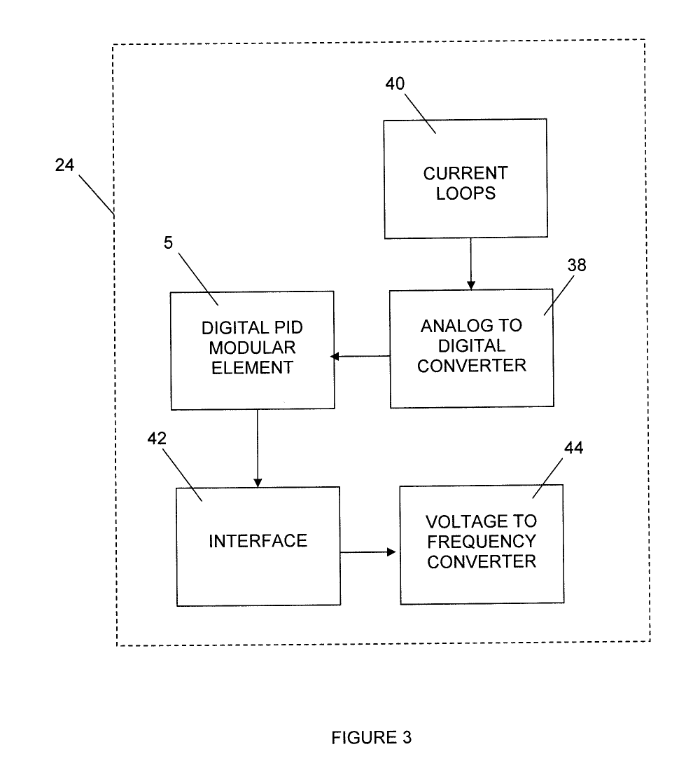

FIG. 3 shows an exemplary embodiment for the control unit 24 comprising a digital PID modular element 5, the input of which may be a 4-20 ma current loop 40, received from the ozone sensors 71. After conversion to a digital signal by the ND converter 38, data is processed by element 5, which can be a microprocessor chip, an OPLC Vision 350, or any controllable programmer. Digital integral-differential calculations usually require significant arithmetic operations with risks of truncation and round-off errors. Therefore, real time constraints may impose certain limitations to this embodiment. Outputs of element 5 may be current loops 4-20 ma driving either the power supply 34 and/or a voltage to frequency converter 44. An interface 42 may be used for connection to the V/F converter 44.

Operations of integration and differentiation can be programmed in any type of digital machine, such as microprocessor type 8096 Intel (with A/D), PIC, PC or industrial controller. However, digital differentiations and integrations usually require thousands of elementary floating point arithmetic operations per second. Moreover, some special instructions may need to be added in case differentiations produce divisions per zero or explodes truncation errors. In real time situations, the PID loop needs to deliver the correct commands to the electrode quickly after a pollution disturbance or excess ozone occurs in the room. Therefore, the embodiment illustrated in FIG. 3 may be appropriate for situations where there are no abrupt pollutant injections, such as in flow regulated water treatment plants, in warehouses where decaying is slow (potatoes) or where no drastic reactant composition, like methane, will be produced. It may also be appropriate when the cost of software development is not critical, display and Ethernet connections are available, and the cost of parts is not critical.

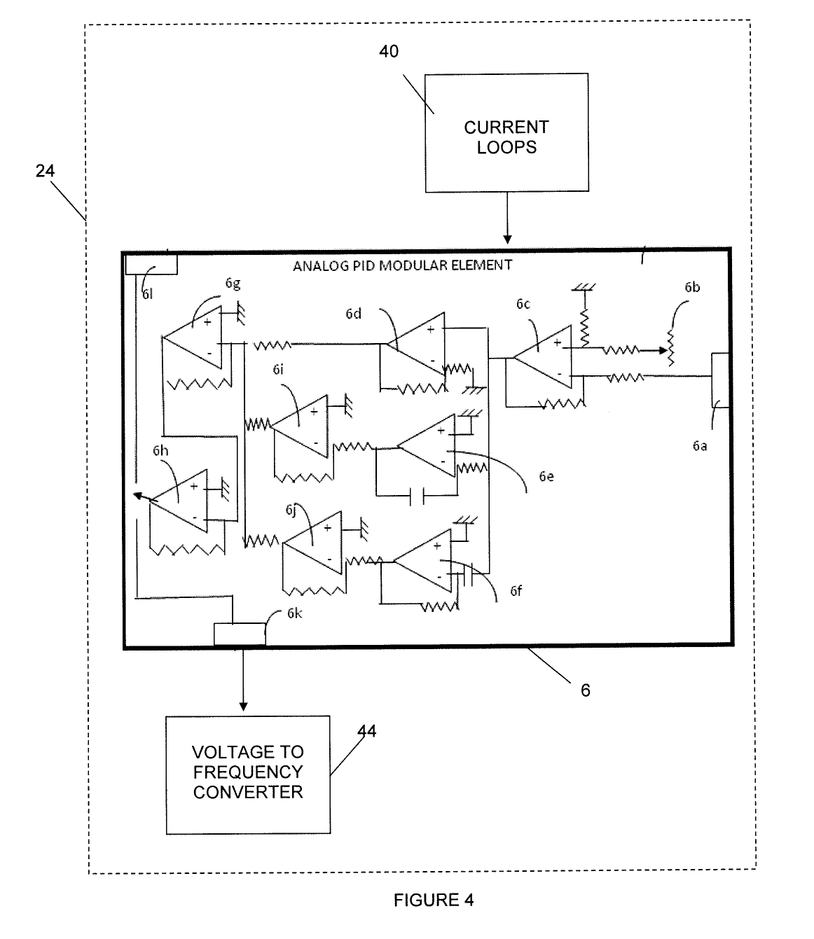

FIG. 4 illustrates an embodiment whereby the control unit 24 comprises an analog PID modular element 6, thereby providing fast and cheap real time integrators and differentiators. In this case, operational amplifiers can be chips such as LM324 or LM741, which cost only a few dollars each. The number of operational amplifiers (op amps) required depends on a degree of sophistication needed to control a particular chemistry. In the average complexity embodiment illustrated, the analog PID modular element 6 inputs are electrical signals received from the ozone sensor unit 71, via the current loops 40 and interface 6a. A potentiometer 6b provides a set point reference from which is subtracted a sensor signal in op amp 6c. An error signal is sent to op amp 6d, which computes a proportional term, to op amp 6e which computes an integral term, and to op amp 6f which computes a derivative term. These three terms are summed in op amp 6g, whose output is sent to interface 6k, via 6h which generates a command current loops of 4-20 ma. Op amps 6i, 6j, 6h act as polarity inverters. Some additional logic components may be added in order to drive valves and relays, as will be described in more detail below. An output of analog PID modular element 6 is sent either via interface 6l to the power supply 34, or via interface 6k to voltage to frequency converter 44.

The embodiment illustrated in FIG. 4 can perform very fast differentiations, summing and other operations. With appropriate test points, results of complex real time operations can be easily followed on an oscilloscope (not shown) and no A/D is needed. Precision IC op amps can be bought for a few dollars. The analog PID 6 can also be appropriate for situations requiring quick reaction times because of sudden burst of pollutants; no display or Ethernet connection; and low costs of parts.

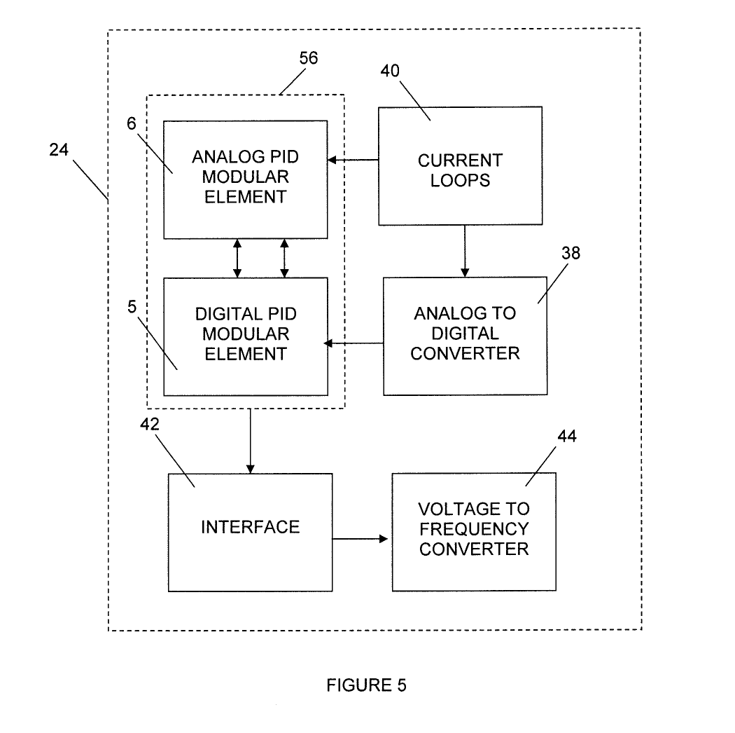

FIG. 5 illustrates an embodiment for the control unit 24 comprising a hybrid PID modular element 56, which is a combination of previous PID modules 5 and 6. This embodiment may be used whenever both fast integration-differentiation and logical operations or mass data memorization are needed. Outputs of the hybrid PID modular element 56 are sent via current loops either to the power supply 34, or via interface 42 to a voltage to frequency converter 44. Hybrid PID module 56 may comprise roughly 50% digital and 50% analog PID modules, and is used when both fast reaction time and routine logical functions (display, Ethernet) are needed. In this case, the analog portion deals with the complexity of integrals and derivatives in real time and the digital portion deals with more conventional, slow, routine management of an ozone generation system.

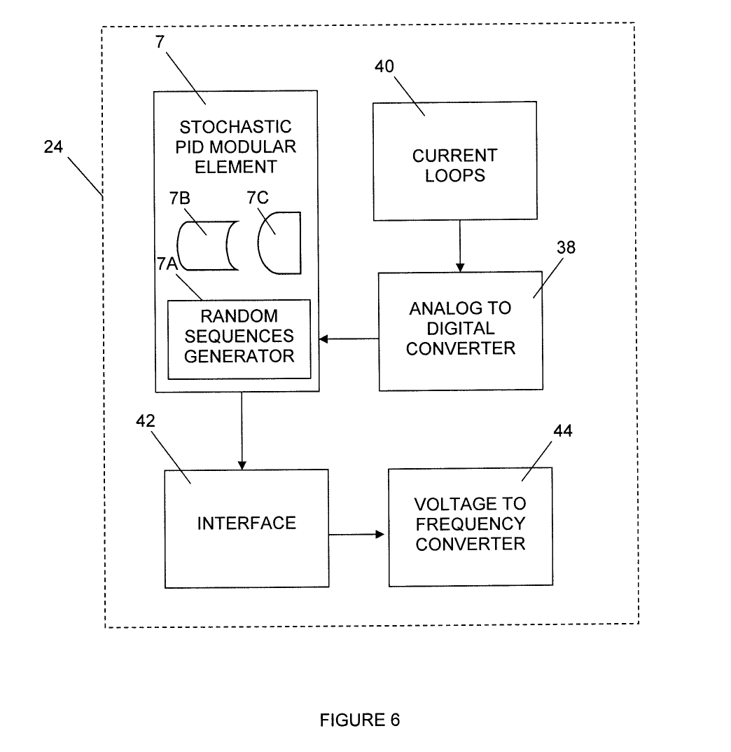

FIG. 6 illustrates an embodiment for the control unit 24 comprising a stochastic PID modular element 7 that may be used whenever the concentrations of reactant, pollutants, and/or aerosols are known substances that provide a coefficient of probability. It may be built around a random sequences generator 7a and logical gating components 7b, 7c. Using such a stochastic PID 7 may facilitate fast reaction time in closed loop. Outputs of stochastic PID modular element 7 are sent via current loops to the power supply 34, or via interface 42 to voltage to frequency converter 44.

Such an embodiment may be appropriate when the nature and amount of pollutants is known in only probabilistic ways. Such a situation is not uncommon in the case of fungus (ex. potatoes), mold (ex. oranges), and bacteria (ex. strawberries), and there are no proper sensors to evaluate their nuisance potentials. Some algorithms may be created using fuzzy logic with a stochastic PID that requires only a random sequence generator and a few gates.

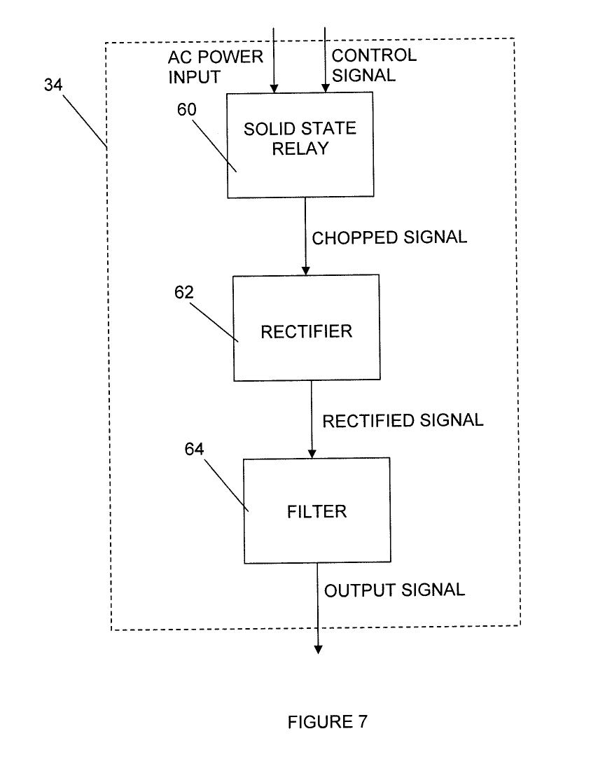

Referring now to FIG. 7, there is illustrated an exemplary embodiment for the power supply 34 of the ozone generation system 20. An AC power input signal is received at a solid state relay (SSR) 60. A small AC power input signal may be used to control a larger load current or voltage. An external control signal is also provided, from the control unit 24. The relay 60 is designed to switch AC to the load and serves the same function as an electromechanical relay. However, it is also used to meter an incoming signal presented to a rectifier 62 by setting a desired conduction angle. The conduction angle thus determines the width of pulses which are fed through to the rectifier 62. The signal output by the solid state relay is therefore chopped, and only a given percentage of the incoming AC power signal is presented to the rectifier 62. The filter 64 then serves to smooth out any increases in the average DC voltage available.

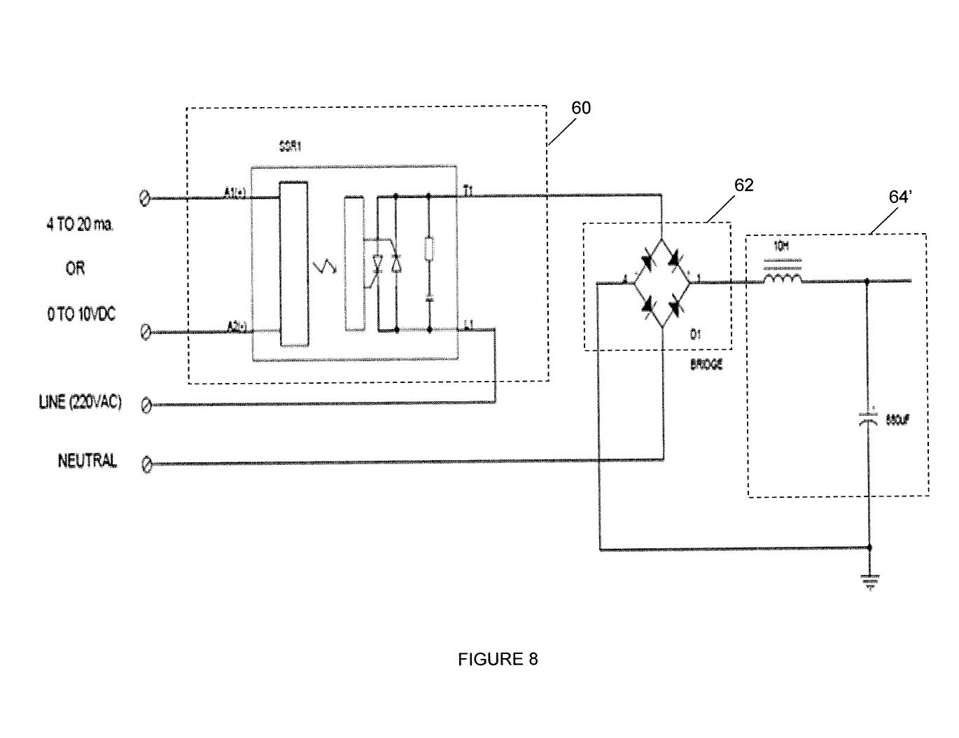

FIG. 8 illustrates an exemplary circuit for the power supply 34. In this embodiment, the SSR 60 uses optical coupling. The control voltage energizes an LED which illuminates switches on a photo-sensitive diode. The diode current turns on a back-to-back thyristor to switch the load. The optical coupling allows the control circuit to be electrically isolated from the load. In an alternative embodiment, the thyristor is replaced by a silicon controlled rectifier or a MOSFET. In addition, the SSR may be a transformer-coupled SSR, or a hybrid SSR (also known as a Reed-Relay-coupled SSR).

The SSR 60 illustrated is designed to be controlled by either a current signal ranging from 4 to 20 ma or a voltage signal ranging from 0 to 10 volts. The SSR 60 passes as much of the AC power input signal as desired, in accordance with control settings. The control settings may be set, for example, via an interface (not shown) under computer control and built into the SSR 60. The SSR's internal power supply allows it to control the angle of conduction down to 0 degrees, i.e. no output, and it will only switch on the zero crossing of the AC signal. This gives two pulses per sine wave, one positive and the other negative. The width of these pulses is controlled by the control signal from 0 to 100 percent. In this embodiment, 1 volt of control will equal 10 percent of the AC sine wave being passed, 5 volts will be 50%, and 10 volts will pass all of the AC sine wave.

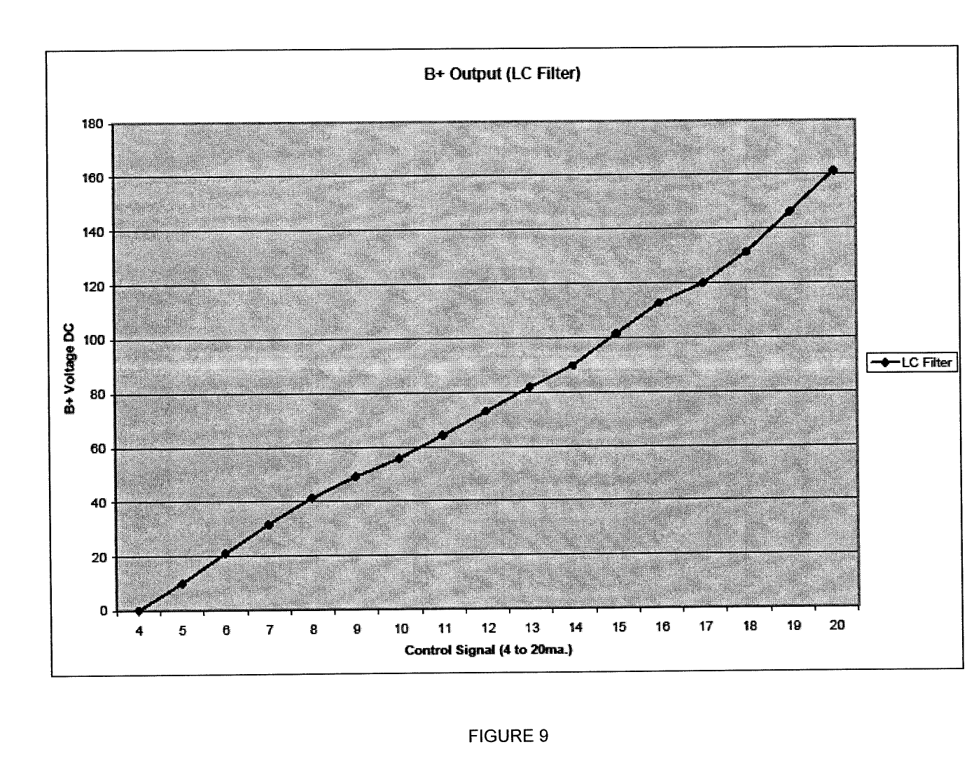

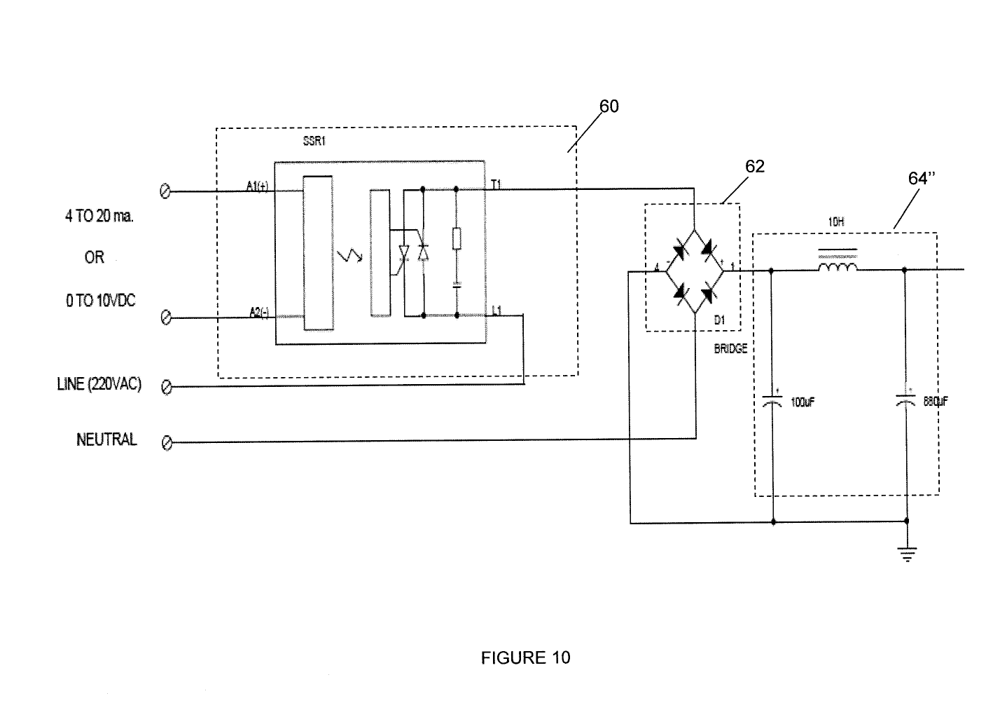

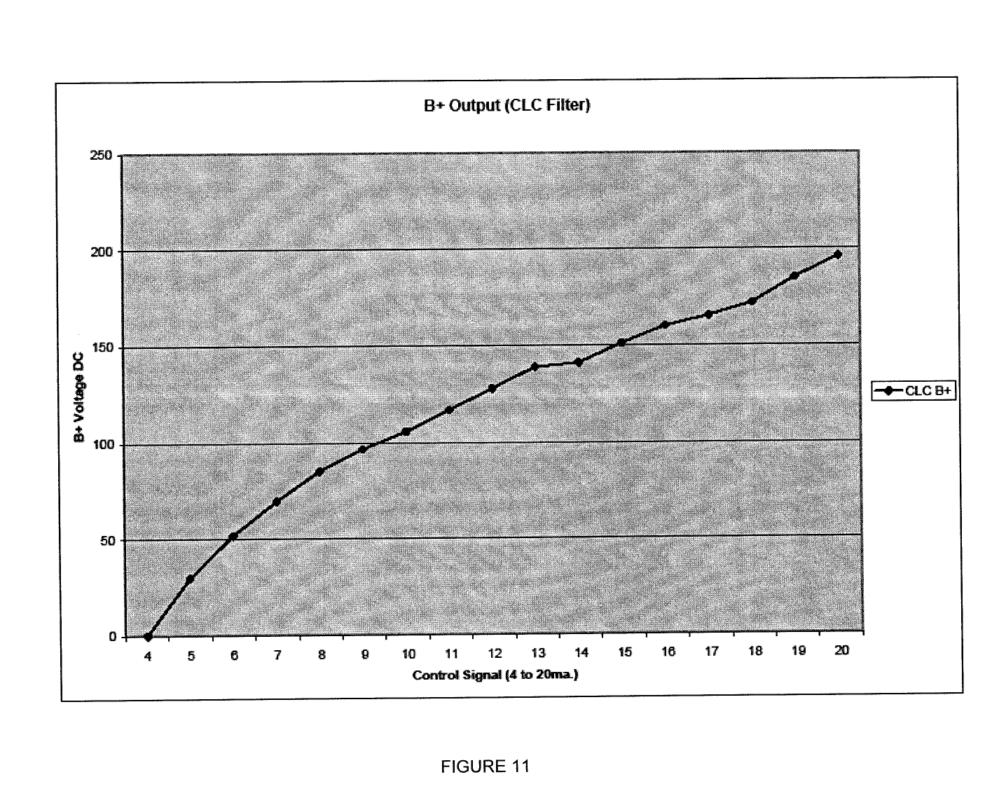

In the embodiment illustrated in FIG. 8, the rectifier 62 is a full wave rectifier. In an alternative embodiment, other types of rectifiers may be used, such as half-wave rectifiers. Implementation of the rectifier 62 may take the form of vacuum tube diodes, mercury arc valves, solid-state diodes, silicon-controlled rectifiers, and other silicon-based semiconductor switches. A rectified signal is fed to a filter 64, illustrated in FIG. 8 as an LC filter 64′. An LC filter 64′ provides a substantially linear output, as is illustrated in FIG. 9. An alternative embodiment is illustrated in FIG. 10, whereby a CLC filter 64” is used. The output of the power supply 34 using the CLC filter 64″ is illustrated in FIG. 11. Compared to the output using the LC filter 64′, a greater range of output voltage is provided. In another alternative embodiment, a C filter may also be used. The embodiments illustrated in FIGS. 8 and 10 for the power supply result in a simple but effective fully variable DC power supply system under full control by an external signal with no sudden rises in a DC capacitor bank under low current conditions. The specify capacitor and inductor values indicated in FIGS. 8 and 10 are illustrative only and may vary.

The graphs of FIGS. 9 and 11 show that a small change in the control signal may result in a somewhat linear change to the output voltage of the power supply 34. For example, as seen in FIG. 9, a change in the control signal from 5.0 ma to 6.0 ma will cause the output voltage to rise from 10 volts to little more than 20 volts. Therefore, a 1 ma change results in no more than 10 volts increase in the output. The linearity of the curve provides an easily controllable output voltage from a low input signal. FIG. 11 shows a greater range for control, with the output voltage being variable from 0 v to almost 200 v, across the 4 to 20 ma control signal range. The described embodiments therefore provide a more accurate adjustment of an applied voltage when the AC power input signal is weak, as well as an external control of the voltage. The precision is provided by a careful metering of the AC power input signal presented to the rectifier 62 using the solid state relay 60. The solid state relay 60 determines the width of the pulses which are fed to the rectifier 62 by setting a desired conduction angle, or angle of flow θ, in accordance with the control signal.

In one embodiment, in order to provide such control on the output of the DC power supply, a zero-crossing, or synchronous, solid-state relay is used. The switching of the relay from a non-conducting to a conducting state occurs when the input voltage reaches the zero-crossing point of the sine wave. This minimizes the surge current through the load during the first conduction cycle and helps reduce the level of conducted emissions placed on the control unit 24. The relay does not allow load current to flow through the output until a next zero-crossing point of an AC sine wave. If the control voltage is removed from the input of the SSR, it stops conducting load current when it reaches the next zero-crossing point of the AC sine wave.

Setting the value of the control signal via the control unit 24, the SSR, and by extension the power supply 34, is under full control of an external signal, and therefore the ozone generator is also under full control of the external signal. Such control may be exercised locally or remotely, thereby offering more flexibility to the operation and maintenance of the ozone generation system. Control of the power supply 34 from 0 to 100% of the output power allows varying the output voltage in a linear manner.

With regards to the application of the described power supply 34 to the ozone generation system 20, the following considerations are met. An ozone generation system 20 should be able to measure accurately the concentration of ozone in any room, especially the residual concentration (down to 1 ppb). It should also be able to quickly vary the production of ozone whenever a concentration of the pollutant increases or decreases. The precise adjustability of the described system from 0 to 100% allows both of these conditions to be met.

In some embodiments, a control unit 24 with substantial computing power may be used in order to generate appropriate commands to the plasma electrode voltages and frequencies. The ozone generation system 20 may be remotely programmable, via Ethernet or similar means. Corona voltage and corona frequency may be controlled to rapidly increase or decrease ozone production. In the case of adding a corona frequency control to a corona voltage control, increasing or decreasing corona frequency at the electrode is tantamount to an increase or decrease of the peak charging current in a somewhat capacitive load, and also the number of micro-discharges per second. This allows changing the amount of chemistry produced without altering its kind, and minimizes risks of arcing. In addition, frequency may be used to increase or decrease ozone production while holding the corona voltage constant. This way, if sensors detect harmful gases, the system will lower the corona voltage until no more harmful gases are produced. It will then shift the frequency up or down to control generation of ozone without producing harmful gases.

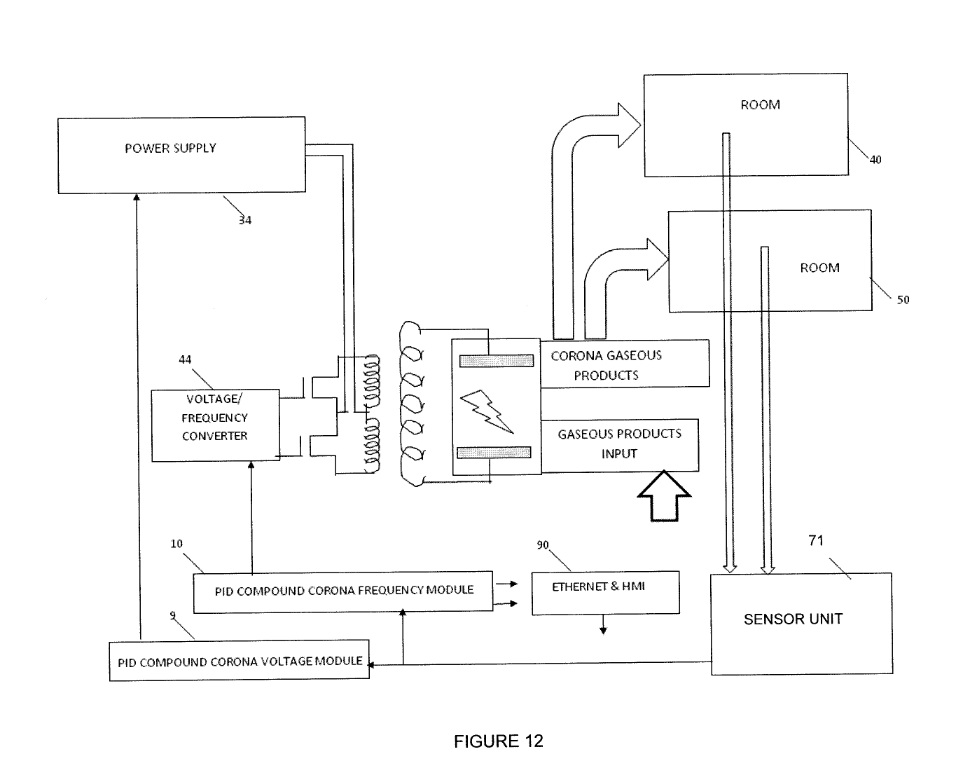

FIG. 12 shows an exemplary corona control system, comprising a corona electrode input of a gaseous product and an output of a corona gaseous product. These corona products may be sent to rooms 40, 50, and others, which may be, for example, offices contaminated by pollutants (e.g. H₂S), warehouses generating unwanted gases (e.g. ethylene), or gas reservoirs (e.g. ozone or hydrogen).

A sensor unit 71 takes continuous measurements of concentrations of gases present in rooms 40, 50, etc., and outputs corresponding electrical signals via current loops 4-20 ma to PID compound corona voltage module 9 and to PID compound corona frequency module 10. The PID compound modules solve the proportional-integral-derivative equations in real time in order to provide optimum control of the corona. In case of large fruit or vegetable warehouses, sensors of many different gases may be used to provide some inputs to the PID control modules 9 and 10. For example, there may be an ethylene sensor for bananas or a carbonic gas sensor for cabbage.

Each of the compound modules 9 and 10 may be designed with digital, analog, hybrid, and/or stochastic PID modular elements, as described above. Modules 9 and 10 provide the corona with the benefits of a tight closed-loop control. A choice of PID modular elements depends on the kind of chemistry to be implemented. For example, it can be anything from simple proportional control to multi-loop integrator differentiator topologies. PID compound corona voltage module 9 outputs, for example, a 4-20 ma current loop that controls the conduction angle of the SSR in the power supply 34.

The PID compound corona frequency module 10 outputs, for example, a 4-20ma current loop that drives the voltage frequency to converter 44 (e.g. AD 654). Module 10 and converter 44 are elements of the present system that may be used when large amounts of ozone are to be produced from the atmospheric air.

Power supply 34 applies a regulated variable voltage to the center tap of a high voltage transformer, of a push-pull type, connected with a set of MOSFETS. Voltage to frequency converter 44 provides the gates of the MOSFETS with 180 degrees out of phase pulses via phase splitters and drivers. A high voltage transformer may be of a lamination type if corona frequencies are below 1000 Hertz, and ferrite core type if corona frequencies are above 1000 Hertz. Compound modules 9 and 10 can be connected to block 90 for remote control of the process via Ethernet, or to a human-machine interface (HMI). Although the Ethernet and HMI connections are shown in the same block, they may be two different elements.

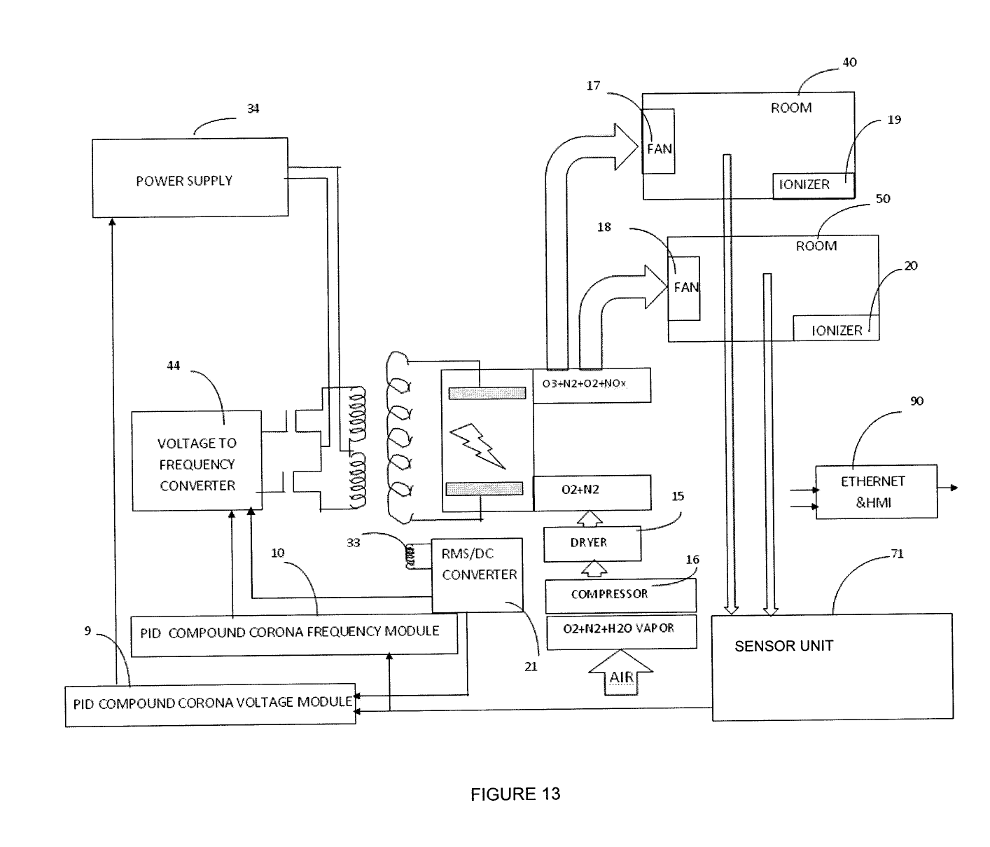

FIG. 13 shows another exemplary ozone generation system adapted to ozone production with corona, in order to neutralize pollutants, pathogens, aerosols, moistures, bad odor gasses in one or several rooms, using the necessary ozone concentrations. The primary reactant, essentially air (O₂+N₂+H₂O vapor), is injected into the system via compressor 16. This gaseous compound is passed through the dryer module 15, in order to eliminate water vapor. This operation reduces the risk of producing nitric acid H₂NO₃ with NOx gasses. The secondary reactant, O₂+N₂, is sent to the tubular corona electrode, which produces a mixture of O₃+O₂+N₂+ potential NOx. This O₃ rich mix is transferred to fans 17, 18 of rooms 40, 50 and others. In this embodiment, modules 19, 20 are negative ionizers used for neutralization of aerosols. Ozone concentrations in rooms 40, 50 and others are measured by ozone sensor unit 71, for example, BMT930 or equivalent.

Electrical signals from ozone sensor unit 71 are sent via current loops, (e.g. 4-20 ma) to compound PID module 9 and to compound PID module 10, which calculate the appropriate current loop command signals to power supply 34, and voltage to frequency converter 44. An RMS value of instant corona voltage may also be used via secondary Vrms winding 33 and RMS/DC converter 21, for example of type AD636 or equivalent. As in FIG. 12, the current loop of compound PID module 9 monitors the conduction angle of 34 and the current loop of compound PID module 10 monitors voltage to frequency converter 44 (for example, AD 654 or equivalent).

The high voltage transformer may be of the lamination type for frequencies below 1000 Hertz, and ferrite core type for frequencies above 1000 Hertz. Note that for certain applications, one might use only the compound PID module 9 (i.e. fixed frequency), or only the compound PID module 10 (i.e. fixed voltage).

FIG. 13 includes the feedback coil 33 for the control loop. This feedback control loop allows to detect a gross fault, such as over voltage on the corona tube. This situation can happen if the control system suffers a breakdown. In this case, the system may automatically shut down the power supply 34. The feedback signal from the feedback control loop may also be used to monitor the output power and supply a warning signal to the control system that its commands are being acted upon.

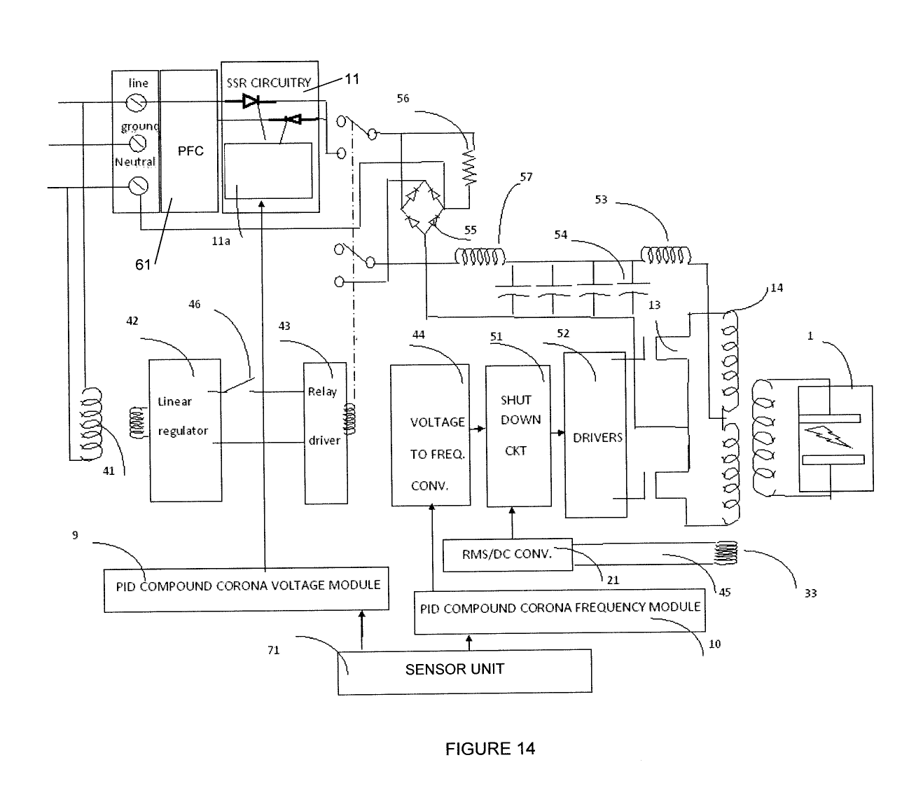

FIG. 14 shows an embodiment of the DC power supply circuitry, in which the power supply phase angle is tightly controlled by a current loop produced by, for example, PID compound module 9. In one exemplary embodiment, the SSR 11 may comprise a Carlo Gavazzi RM1 E component 11a, or equivalent. When power switch 46 is closed, relay 43 operates and connects switched line 115 VAC or 220 VAC to bridge 55, which rectifies arcs of sinusoids. Power resistor 56 provides some minimum load. At the same time, relay 43 connects the positive side of bridge 55 to inductor 57 which then connects to a bank of capacitors 54 which forms, with choke 53, a power filter. The output of this filter can vary from 0% to 100%, i.e. 0V DC to 100V DC (115VAC input) under PID control 9. This voltage is applied to the center tap of high voltage transformer 14, which produces 0-10,000 volts peak at secondary. The peak high voltage produced may vary, among other things, with the electrode capacitance.

Corona frequency is produced by voltage to frequency converter 44 (fixed or V/F type), which produces out-of-phase pulses for power FETS 13 via drivers 52. Secondary winding 33 delivers 7 Vrms to RMS to DC converter 21, the output of which is sent to shut down circuit 51. Shut down circuit 51 cuts off drives to MOSFET gates when the corona voltage reaches forbidden values. Element 45 is a feedback loop. A voltage of 12 VDC, for energizing the control circuits, is derived from transformer 41 and linear regulator 42. Some power factor correction 61 (PFC) be built around the SSR circuitry 11.

FIG. 15 shows an exemplary ozone sensor unit 71, wherein samples of air from different rooms are input through a six-channel duct 60. The control logic may be designed to shut down the ozone power supply 34 if ozone measurement is more than a specific high concentration. The ozone sensor unit 71 may have two scrubbers 71a, 71b for ambient ozone monitoring. It may also have a built-in ozone generator sub-module 71c for intermittent automatic testing of the utility scrubber. If this scrubber fails in completely removing the ozone from the sample ozonated by the ozone generator sub-module 71c, the instrument may automatically switch from the utility scrubber 71a to the reserve scrubber 71b, and activate a warning signal indicating scrubber failure. Ozone spectro 71d is a device that measures ozone by absorption of UV. Interface 71e is a particular interface of the instrument. In some embodiments, the minimum detectable concentration by the instrument may be 2 ppb, with an accuracy of 1%, and maximum noise of 1 ppb. A BMT930 (Bmt Messtechnik GMBH), or equivalent, may be used for such requirements.

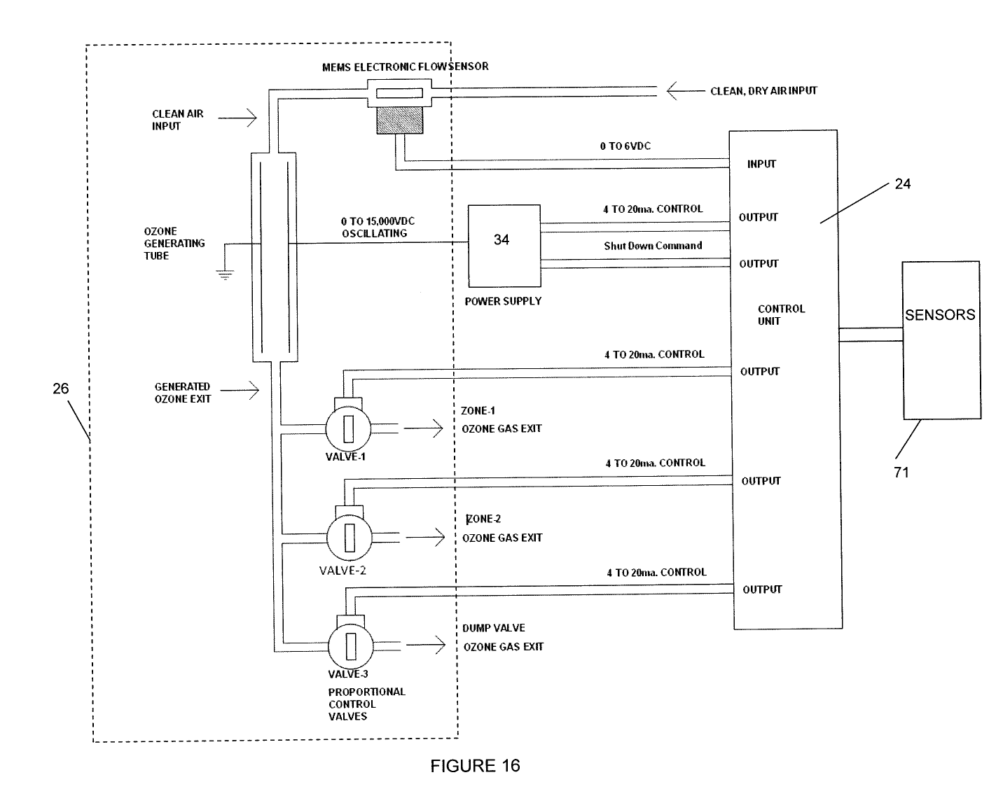

FIG. 16 is an exemplary embodiment of the ozone generation system 20 showing the ozone generator 26 with a system of electronically controlled proportional control valves to deliver the generated ozone. A flow meter takes clean, dry air as input and provides it to one or more ozone generating tubes. A reading of the air flow is provided to the control unit 24. The generated ozone is delivered through one or more output valves, and a dump valve is used as an ozone gas exit in case the one or more output valves are fully closed and ozone needs to be released.

Each of the one or more valves may be associated with a distinct zone. As detected ozone levels rise in a zone, the control system can close the control valve of that zone, either completely or partially, to reduce the amount of ozone reaching that zone. By monitoring the air flow into the generating tubes the proportional output valves may be safely controlled by using the dump valve to ensure adequate air flow through the system. In addition, the opened, closed, or partially opened status of a valve may be determined based on the gas analyzer and the air flow sensor, or based on a desired to increase or decrease the voltage to the generating tubes from the power supply.

In the example shown in FIG. 16, two zone valves and a dump valve are provided, along with the electronic flow meter. On power up, all valves may be open. The system may then close the dump valve. If the air flow meter is indicating, for example, 30 LPM (liters per minute) as entering the ozone generating tube, the system may want to ensure this flow stays at substantially 30 LPM. If exit zone #2 starts to show an increase in ozone in the target space, as reported by the sensor unit 71, the system will start to close the electronically controlled proportional control valve for Zone #2. As this valve is closed a little, the detected clean air input flow as seen by the flow meter may drop. The system may then open the dump valve proportionally. This will return the air flow back to 30 LPM. If the detected ozone in this zone continues to rise, the system will continue to close the exit control valve for this zone while at the same time opening the dump valve to maintain the 30 LPM flow rate.

At some point, the system can decide to stop closing the exit valve and start reducing the high voltage being generated by the power supply 34 and being supplied to the ozone generating tube. This will reduce the volume of ozone being generated for the complete system. As ozone levels start to drop in zone #2, the system will then start to open the exit control valve for zone #2 while again closing the dump valve proportionally to maintain the system's 30 LPM air flow rate. At the same time, the system may return the power supply 34 to a higher output voltage to again start generating ozone at a higher rate.

In the example of FIG. 16, the exit control valves are 4 to 20 ma controlled proportional air valves. The air flow sensor is a MEMS type air flow meter with a 0 to 6 vdc output signal which indicates a range of 0 to 50 LPM of air flow. In this example, the air flow meter would be outputting approximately 4 vdc for a flow of 30 LPM. In an alternative embodiment, the valves may be on/off type valves.

Having the air flow sensor located in the clean air flow at the input to the ozone generating tubes means that no special materials are required for this unit to protect it from the ozone. Therefore, any suitable electronic air flow sensor with variable output signal can be used. Alternatively, the flow sensor may be provided at another location, with the appropriate protection from the ozone.

In some embodiments, the dump valve is a normally open-type valve controlled by a 4 to 20 ma control signal. The ozone exiting this valve can be sent to an air exhaust duct and be discharged outside the building. As an additional security feature, if the air flow drops below 20 LPM (for example) the control unit 24 can shut down the power supply 34 to protect the ozone generating tube from being damaged as not enough air is flowing through the tube for proper operation.

In an alternative embodiment, If the sensors detect a higher then desired level of ozone in an exterior zone, the system can simply close the valve for that zone completely. This would shut down all ozone being delivered to that zone. When the system shuts down a zone, it will then need to open the dump valve to substantially maintain the original air flow as reported by the air flow meter. Using this approach may cause the air flow to vary a bit more then in a proportional system. However, such a variation is relatively small. For example, for a 30 LPM air flow, there may be a 2 or 3 LPM difference between all valves open and all closed with the dump valve open.

While illustrated in the block diagrams as groups of discrete components communicating with each other via distinct data signal connections, it will be understood by those skilled in the art that some of the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. The embodiments of the invention described above are intended to be exemplary only. The scope of the invention is therefore intended to be limited solely by the scope of the appended claims.

1. An ozone generation system comprising:
an ozone generator adapted to deliver a given amount of ozone in a space in order to obtain a target concentration therein;
a variable direct current power supply connected to the ozone generator and having a first input for receiving an alternating current power signal and a second input for an external control signal;
a control unit connected to the second input of the power supply for generating the external control signal, the external control signal being generated in accordance with an amount of ozone required in order to reach the target concentration; and
an ozone sensor connected to the control unit and adapted to measure a residual amount of ozone in the space and provide the control unit with a measurement signal of the residual amount for determining the amount of ozone required.

2. The ozone generation system of claim 1, wherein the power supply is controllable from substantially 0% to substantially 100% of an available output voltage.

3. The ozone generation system of claim 1, wherein the power supply comprises a solid-state relay connected to an input of a rectifier, for metering an amount of the alternating current power signal presented to the rectifier, and a filter connected to an output of the rectifier for smoothing out a rectified signal and presenting the rectified signal to the ozone generator.

4. The ozone generation system of claim 1, wherein the filter is one of an inductor-capacitor filter and a capacitor-inductor-capacitor filter.

5. (canceled)

6. The ozone generation system of claim 1, wherein the external control signal is one of an alternating current signal from about 4 ma to about 20 ma and a direct current signal from about 0 volts to about 10 volts.

7. (canceled)

8. The ozone generation system of claim 1, wherein the rectifier is a full-wave rectifier.

9. The ozone generation system of claim 1, wherein the control unit comprises a Proportional-Integral-Derivative (PID) controller.

10. The ozone generation system of claim 1, wherein the control unit comprises a control device to vary a corona frequency and a corona voltage, a control loop feedback mechanism, and an interface for setting control parameters.

11. The ozone generation system of claim 10, wherein the control unit is adapted for setting the control parameters remotely.

12. The ozone generation system of claim 1, wherein the ozone generator comprises at least one output valve for selectively outputting generated ozone into the space and at least one dump valve for disposing of ozone when the at least one output valve is closed.

13. The ozone generation system of claim 12, wherein the at least one output valve is a proportional control valve controlled by the control unit.

14. The ozone generation system of claim 12, wherein each one of the at least one output valve is associated with a given zone in the space, and is controlled in accordance with ozone to be delivered to the given zone.

15. The ozone generation system claim 12, wherein the ozone generator comprises a flow sensor for measuring a flow rate of clean air provided to an ozone generating tube inside the ozone generator, and the flow rate as measured is provided to the control unit.

16. The ozone generation system of claim 15, wherein the flow sensor is an electronic flow sensor provided upstream from the ozone generating tube, in an input path thereof.

17. A method for generating ozone in a space, the method comprising:
measuring a concentration of residual ozone in the space;
determining, from the concentration measured, an amount of ozone required for providing a target concentration of ozone in the space;
generating an external control signal for energizing a variable direct current power supply, the external control signal having a value selected in accordance with the amount of ozone required;
energizing the variable direct current power supply with the external control signal and supplying the direct current power supply with an alternating current power signal;
metering an amount of the alternating current power signal allowed to flow through the variable direct current power supply by varying a conduction angle thereof, thereby causing the variable direct current power supply to output a predetermined voltage level to an ozone generator; and
delivering the amount of ozone required for providing the target concentration in the space.

18. The method of claim 17, wherein metering an amount of the alternating current power signal comprises metering from substantially 0% to substantially 100% of the alternating current power signal.

19. The method of claim 17, wherein metering an amount of the alternating current power signal comprises chopping the alternating current power signal using a solid state relay, rectifying a chopped signal, and filtering a rectified signal to provide the predetermined voltage level to the ozone generator.

20. The method of claim 17, wherein energizing the variable direct current power supply comprises providing the variable direct current power supply with one of an alternating current control signal from about 4 ma to about 20 ma and a direct current control signal from about 0 volts to about 10 volts.

21. (canceled)

22. The method of claim 17, wherein energizing the variable direct current power supply comprises energizing upon a zero-crossing of the alternating current power signal.

23. The method of claim 17, wherein causing the variable direct current power supply to output a predetermined voltage level comprises outputting a predetermined voltage level that is substantially linear with respect to the external control signal.

24. (canceled)

25. (canceled)

26. The method of claim 17, wherein delivering the amount of ozone comprises selectively opening and closing at least one output valve, and selectively opening at least one dump valve when the at least one output valve is closed.

27. (canceled)

28. The method of claim 26, wherein delivering the amount of ozone comprises selectively delivering the ozone to at least two zones of the space, each one of the at least two zones having at least one of the at least one output valve assigned thereto.

29. The method of claim 26, further comprising measuring a flow rate of a clean air input, and using the flow rate as measured to dynamically open and close the at least one output valve and the at least one dump valve.

30. A fully variable direct current power supply having a first input for receiving an alternating current power signal and a second input for an external control signal, the power supply comprising a solid-state relay and a rectifier, the solid state relay, connected to an input of the rectifier, adapted for metering the alternating current power signal presented to the rectifier from substantially 0% to substantially 100%, and a filter connected to an output of the rectifier for smoothing out a rectified signal and outputting a direct current voltage signal.

31. A method for generating a direct current voltage signal, the method comprising energizing the variable direct current power supply with an external control signal and an alternating current power signal, metering from substantially 0% to substantially 100% an amount of the alternating current power signal allowed to flow through the variable direct current power supply as a function of the external control signal by varying a conduction angle thereof using a solid state relay, rectifying an output of the solid state relay, filtering a rectified signal, and outputting a direct current voltage signal.
